(19) United States
(12) Patent Application Publication
(10) Pub. No.: US 2003/0097723 A1
(43) Pub. Date: May 29, 2003

(54) Transmission device of electric toothbrush

(76) Inventor: Ming-Kuei Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/993,557

(22) Filed: Nov. 27, 2001

(51) Int. Cl. A61C 17/34

(52) U.S. Cl. 15/22.1; 15/28

(57) ABSTRACT

A transmission device of electric toothbrush includes a handle assembly, a brush assembly, and a transmission mechanism. The handle assembly has a shaft coupled to the brush assembly so that the brush assembly is rotatable about the handle assembly. The transmission mechanism is mounted on the handle assembly and comprising a coupling member, a transmission shaft, the coupling member being coupled to the brush assembly so as to move together, a groove on the coupling member, and a transmission rod at one bent end of the transmission shaft being engaged within the groove. Hence, the brush assembly is operative to rotate and vibrate.

### FIELD OF THE INVENTION

The present invention relates to electric toothbrush and more particularly to a transmission device of electric toothbrush capable of providing rotation and vibration as well as adjusting rotational angle and amplitude of vibration of the brush.

### BACKGROUND OF THE INVENTION

Electric toothbrushes have been widely used throughout the world. Young children or persons having a physical disability especially like to use it because it requires less effort. As known that transmission device is the most important element of electric toothbrush. Conventionally, bristles are rotated and vibrated in high speed as transmission device is activated for cleaning the teeth. However, the prior art does not provide a mechanism for adjusting a rotational angle or an amplitude of vibration. User is only allowed to adjust toothbrush's operating speed. This limits electric toothbrush's application. Thus improvement exists.

### SUMMARY OF THE INVENTION

It is an object of the present invention to provide a transmission device of electric toothbrush capable of providing rotation and vibration as well as adjusting rotational angle and amplitude of vibration of the brush so as to increase its capabilities.

To achieve the above and other objects, the present invention provide a transmission device of electric toothbrush including a handle assembly, a brush assembly, and a transmission mechanism, the handle assembly having a shaft coupled to the brush assembly so that the brush assembly is rotatable about the handle assembly, the transmission mechanism being mounted on the handle assembly and comprising a coupling member, a transmission shaft, the coupling member being coupled to the brush assembly so as to move together, a groove on the coupling member, and a transmission rod at one bent end of the transmission shaft being engaged within the groove whereby the brush assembly is operative to rotate and vibrate.

The above and other objects, features and advantages of the present invention will become apparent from the following detailed description taken with the accompanying drawings.

### BRIEF DESCRIPTION OF THE DRAWINGS

FIG. 1 is an exploded view of an electric toothbrush incorporating a transmission device according to the invention;

FIG. 2 is a rear plan view of FIG. 1 electric toothbrush; and

FIG. 3 is a cross-sectional view of FIG. 1 electric toothbrush.

### DETAILED DESCRIPTION OF THE PREFERRED EMBODIMENTS

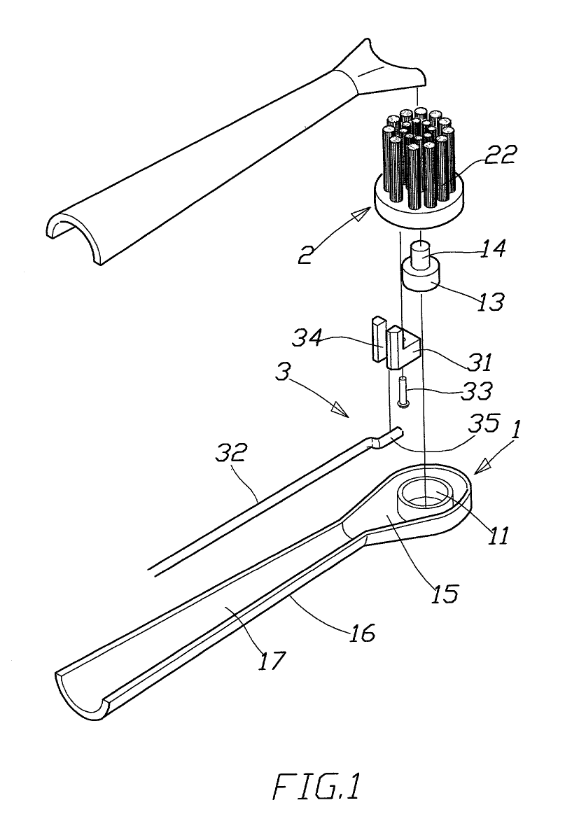

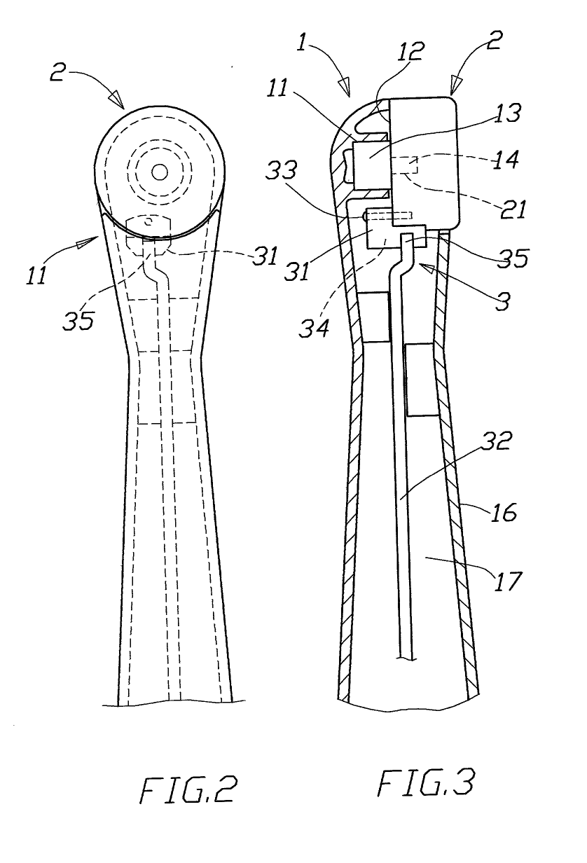

Referring to FIGS. 1 to 3, there is shown an electric toothbrush in accordance with the invention. Electric toothbrush comprises a handle assembly 1 including a central circular recess 11, a peripheral slot 12, a receiving space 15, a cylindrical member 13 frictionally secured in the central circular recess 11 (note that the cylindrical member 13 may be integrally formed with handle assembly 1 in any of other embodiments), a shaft 14 extended upwardly from the cylindrical member 13, an elongate handle 16, and a channel 17 surrounded by the handle 16 and being in communication with the receiving space 15; a brush assembly 2 disposed on the central circular recess 11 and the peripheral slot 12 and including a bottom hole 21 for rotatably receiving the shaft 14, and a plurality of apertures 22 for receiving a plurality of bristles extending upwardly; and a transmission mechanism 3 including a transmission shaft 32 received in the channel 17, one end of transmission shaft 32 being coupled to an electric drive device (not shown), a transmission rod 35 at the other end of transmission shaft 32 wherein transmission rod 35 is parallel to or at a predetermined angle with respect to transmission shaft 32 after the joint of transmission shaft 32 and transmission rod 35 has been bent, a coupling member 31 received in the receiving space 15, a longitudinal groove 34 on one side of coupling member 31 having a width slightly wider than the diameter of transmission rod 35 so as to allow transmission rod 35 to move and rotate freely therein, and a pin 33 passed through coupling member 31 to secure to the bottom side of brush assembly 2.

In operation, transmission shaft 32 is rotated by the activating electric toothbrush. Also, coupling member 31 is activated due to the connection of transmission rod 35 and longitudinal groove 34 And in turn, brush assembly 2 is rotated and vibrated about the cylindrical member 13 by coupling to driven coupling member 31. At this time, user can use electric toothbrush to clean the teeth. Most importantly, rotational angle and amplitude of vibration of one of a variety of brush assemblies 2 can be adjusted by adjusting a distance between transmission rod 35 and transmission shaft 32, a distance between pin 33 and the cylindrical member 13, or an angle of transmission rod 35 with respect to transmission shaft 32. In brief, the invention can effect a brush assembly having various rotation and vibration capabilities by a simple distance or angle adjustment thereof.

While the invention herein disclosed has been described by means of specific embodiments, numerous modifications and variations could be made thereto by those skilled in the art without departing from the scope and spirit of the invention set forth in the claims.

What is claimed is:

1. A transmission device of electric toothbrush including a handle assembly, a brush assembly, and a transmission mechanism, said handle assembly having a shaft coupled to said brush assembly so that said brush assembly being rotatable about said handle assembly, said transmission mechanism being mounted on said handle assembly and comprising a coupling member, a transmission shaft, said coupling member being coupled to said brush assembly so as to move together, a groove on said coupling member, and a transmission rod at one bent end of said transmission shaft being engaged within said groove whereby said brush assembly is operative to rotate and vibrate.

2. The transmission device of electric toothbrush of claim 1, wherein said handle assembly further comprises a recess and a cylindrical member rotatably coupled to said brush assembly by an insertion of said shaft into said recess.

3. The transmission device of electric toothbrush of claim 2, wherein said cylindrical member is integrally formed with said handle assembly and said handle assembly is rotatably coupled said brush assembly by the insertion of said shaft into said recess.

4. The transmission device of electric toothbrush of claim 1, wherein said handle assembly further comprises a receiving space for receiving said coupling member.

5. The transmission device of electric toothbrush of claim 1, wherein said handle assembly further comprises an elongate handle and a channel surrounded by said handle, said channel being in communication with the receiving space and for receiving said transmission shaft.

6. The transmission device of electric toothbrush of claim 1, wherein said brush assembly comprises a plurality of apertures for receiving a plurality of bristles extending upwardly.

7. The transmission device of electric toothbrush of claim 1, wherein said transmission mechanism further comprises a pin passed through said coupling member to secure to said brush assembly.

8. The transmission device of electric toothbrush of claim 1, wherein said transmission rod is parallel to said transmission shaft.

9. The transmission device of electric toothbrush of claim 1, wherein said transmission rod is at a predetermined angle with respect to said transmission shaft.

10. The transmission device of electric toothbrush of claim 1, wherein said groove has a width wider than a diameter of said transmission rod.
